(19) United States
(12) Patent Application Publication
(10) Pub. No.: US 2002/0157967 A1
(43) Pub. Date: Oct. 31, 2002

(54) Electrochemical gaseous chlorine sensor and method for making the same

(75) Inventors: Tzong-Rong Ling, Taoyuan (TW); Cheng-Ming Chang, Taipei (TW); Tse-Chuan Chou, Tainan (TW)

Correspondence Address: BACON & THOMAS, 4th Floor, 625 Slaters Lane, Alexandria, VA, 22314, US

(73) Assignee: Institute of Ocupational Safety and Health, Council of Labor Affairs, Executive Yuan, Taipei (TW)

(21) Appl. No.: 09/791,559

(22) Filed: Feb. 26, 2001

(51) Int. Cl. G01N 27/406

(52) U.S. Cl. 205/778.5; 204/421

(57) ABSTRACT

The present invention relates to an electrochemical gaseous chlorine sensor. The sensor is characterized by covering one of the electrodes with a polymer material having a sensing activity and conductivity. The sensor includes: an ionic permeable film for separating a measuring chamber and a reference chamber, the ionic permeable film being a solid polymer electrolyte; a first electrode and a second electrode formed on two opposite sides of the ionic permeable film, the first electrode and the second electrode being conductors with catalytic activities; and a conductive polymer film formed on the first electrode. A fixed voltage ranging from −0.3 to 1.3V, preferably 0 to 0.2V, between said first electrode and said second electrode is maintained with a device, when the sensor is in use.

### FIELD OF THE INVENTION

The present invention relates to an electrochemical gas sensor, particularly a gaseous chlorine sensor and a method for making the same.

### BACKGROUND OF THE INVENTION

Gaseous chlorine is an indispensable intermediate material in the industry and is mainly used in the acid and alkali industry, the plastic industry, the sterilization industry, the pesticide industry, waste water treatment and the tapwater industry, etc. The annual production of chlorine gas of Taiwan is about three million tons. Chlorine gas is a toxic gas and is an industrial toxic gas under control. Dry chlorine does not strongly corrode objects. However, in the presence of water molecules, chlorine will generate a serious corrosion. Human organs, such as eyes, nose and mouth, that are covered with a mucous membrane and moisture, will react immediately with chlorine gas to form a nascent state oxygen (‘O’).

Cl₂+H₂O→2HCl+(‘O’)

The nascent state oxygen is highly toxic to the protoplasm of cells and the chemical irritation of HCl to cells also causes serious damage. According to the standards of operation environment for labor promulgated by the Taiwan government in 1995, the maximum tolerance of exposure is 0.5 ppm in 8 hours for a human body. This figure indicates that chlorine gas is significantly more toxic than the other toxic gases.

Generally speaking, the most important protective measures used by the industry is the installation of sensors. Currently, according to the principles, the sensors of chlorine gas are essentially divided into three types: the semiconductor type disclosed in U.S. Pat. No. 5,106,479, the constant potential electrolysis type disclosed in U.S. Pat. No. 4,184,937, U.S. Pat. No. 5,538,620, and the high temperature solid state inorganic electrolyte type disclosed in U.S. Pat. No. 5,841,021. The semiconductor type sensor has a low production cost but a poor selectivity. The selectivity of the constant potential electrolysis type is high, but its liquid electrolyte is easy to leak out. And the high temperature solid state inorganic electrolyte type sensor needs to be operated at a high temperature. Each type of sensor invariably has its pros and cons and applicable scope and conditions.

In view of the leakage problem existed in a conventional constant potential electrolysis type sensor, the present invention uses a solid state polymer electrolyte to replace the conventional liquid electrolyte and prepare a gaseous chlorine sensor without generating the leakage problem. Furthermore, usually a sensitive material or an electrode material is formed on a solid state polymer film, and the bonding of the sensitive material and the metal electrode to the solid state polymer film is poor, and thus causes a poor adhesion or easily peeling off of the sensitive material or the electrode, thereby causing a poor sensitivity in detection, unstable signals or even generation of delamination and shortening the operation life of the sensor. Therefore, the present invention provides a gaseous chlorine sensor and a method for making the same. According to the present invention, the sensitive material and the metal electrode can be reliably attached to the polymer film while improving the sensitivity and the operation life of the sensor.

### SUMMARY OF THE INVENTION

The present invention provides an electrochemical sensor for measuring the concentration of chlorine gas. The sensor is characterized in covering an electrode with a conductive polymer material active in sensing to increase the fastness, sensitivity and stability of the electrode. Meanwhile, the sensor will not generate the leakage problem and is convenient for miniaturization. Said sensor comprises an ionic permeable film for separating a measuring chamber and a reference chamber. The ionic permeable film is selected from a solid polymer electrolyte (SPE), preferably Nafion®117e. The sensor further comprises a first electrode and a second electrode separately formed on two opposite sides of the ionic permeable film. Said first electrode is formed on the side of the ionic permeable film close to the measuring chamber; while said second electrode is formed on the other side of the ionic permeable film close to the reference chamber. Said first and second electrodes are selected from a metal with catalytic activity, such as Pt. Said sensor further comprises an active and conductive polymer film formed on said first electrode by a polymerization method. Said conductive polymer film is selected from a conductive polymer, preferably a polyaniline. Furthermore, said sensor comprises means for maintaining a voltage of −0.3 to 1.3V, preferably 0 to 0.2V, between the first electrode and the second electrode.

The polymerization method includes: a cyclic voltametric polymerization method, a potentiostatic polymerization method, and a chemical oxidation polymerization method, in which the cyclic voltametric polymerization method generates best results in measurement. Said cyclic voltametric polymerization method comprises conducting an electrolysis reaction in a solution having a monomer concentration of aniline of 0.05-0.4M by using the first electrode as a working electrode, a counter electrode, and a potential of said first electrode with respect to an Ag/AgCl reference electrode varying from −0.3 to 1.3V with an scanning rate of 20-35 mV/sec, for 10-20 cycles. Said means has a function of measuring current flowing through said first electrode, i.e. a potentiostat and ampere meter. Said measuring chamber can be introduced with a gas under measurement and said reference chamber can be introduced with a reference gas. Said reference gas can be selected from air, nitrogen gas and oxygen gas.

Said first and second electrodes have gas permeability and catalytic activity. The electrode material is selected from gold, platinum, rhodium and palladium, preferably platinum. The formation method of the first and second electrodes is a reduction immersion method comprising contacting said ionic permeable film with a solution containing Pt ions and reducing Pt ions adsorbed to said ionic permeable film to Pt metal.

Said solid polymer electrolyte is a perfluorocarbon polymer, including: Nafion®NR50, Nafion®117, and Nafion®417&415 from DuPont Co., sulfonic-acid type and carboxylic-acid type polymers from Dow Chemicals Co. Said conductive polymer includes: polyaniline, polyacetylene, polyparaphenylene, polyfuran, polythiophene, polypyrrole, polycarbazole, and polyiminodibenzyl.

The method for producing an electrochemical gaseous chlorine sensor according to the present invention comprises: using an ionic permeable film which separates a measuring chamber from a reference chamber, said ionic permeable film being a solid polymer elecctrolyte (SPE), preferably Nafion®117; forming a first electrode and a second electrode separately on the two sides of the ionic permeable film, said first electrode being formed on the side of the ionic permeable film closer to the measuring chamber, and said second electrode being formed on the side of the ionic permeable film closer to the reference chamber, said first electrode and said second electrode being a catalytically active conductor selected from a metal, preferably Pt; using a polymerization method to form an active and conductive polymer film on said first electrode, said film being selected from a conductive polymer, preferably polyaniline; and using means for maintaining a voltage of −0.3 to 1.3V, preferably 0 to 0.2V, between said first electrode and said second electrode.

### BRIEF DESCRIPTION OF THE DRAWINGS

The present invention is further elaborated in greater detail in the following in conjunction with figures, wherein

FIG. 1: A device used to produce the first electrode and the second electrode by an immersion reduction method according to the present invention;

FIG. 2: A system used to form a conductive polymer on an electrode by an electro-polymerization method according to the present invention;

FIG. 3: A system for testing a gaseous chlorine sensor of the present invention;

FIG. 4: A variation of sensed current by a PAni-Pt/Nafion/Pt gaseous chlorine sensor according to the present invention at a concentration of chlorine gas of 101 ppm. The conditions of electro-polymerization are: monomer concentration 0.2 M aniline, auxiliary electrolyte 0.5M H₂SO₄, working voltage −0.3⇄1.3V (with respect to reference electrode Ag/AgCl), scanning rate 20 mV/sec, for 20 cycles. The sensing conditions are: working voltage 0V, gas flowrate 100 mL/min, and concentration of chlorine gas 101 ppm;

FIG. 5: A variation of sensed current by a PAni-Pt/Nafion/Pt gaseous chlorine sensor according to the present invention at a concentration of chlorine gas of 0.8 ppm. The conditions of electro-polymerization are: monomer concentration 0.4M aniline, auxiliary electrolyte 0.5MH₂SO₄, working voltage −0.3⇄1.3V (with respect to reference electrode Ag/AgCl), scanning rate 20 mV/sec, for 15 cycles. The sensing conditions are: working voltage 0V, gas flowrate 100 mL/min, and concentration of chlorine gas 0.8 ppm;

FIG. 6: A variation of sensed current by a PAni-Pt/Nafion/Pt gaseous chlorine sensor according to the present invention at a concentration of chlorine gas of 271 ppm. The conditions of chemical oxidation polymerization are: oxidant 0.1MFeCl₃/1N HCl, monomer concentration 0.4 M aniline, polymerization time 100 hours. The sensing conditions are: working voltage −0.1V, gas flowrate 100 mL/min, and concentration of chlorine gas 271 ppm; and

FIG. 7 shows the relationship between the working voltage and the response current detected with a PAni-Pt/Nafion/Pt gaseous chlorine sensor according to the present invention at a concentration of chlorine gas of 2.2 ppm. The conditions of electro-polymerization are: monomer concentration 0.2 M aniline, auxiliary electrolyte 0.5M H₂SO₄, working voltage −0.3⇄1.3V (with respect to reference electrode Ag/AgCl), scanning rate 20 mV/sec, for 10 cycles. The sensing conditions are: working voltage OV, gas flowrate 100 mL/min, and concentration of chlorine gas 2.2 ppm.

### DETAILED DESCRIPTION OF THE PRESENT INVENTION

Conductive polymers have been developed rapidly in the recent decade. Due to their characteristics, the conductive polymers have gradually replaced metal materials. The propagation of electrons of conjugated bonds in the molecules is the key factor affecting the conductive characteristics. Common conductive polymers are shown in the followings:

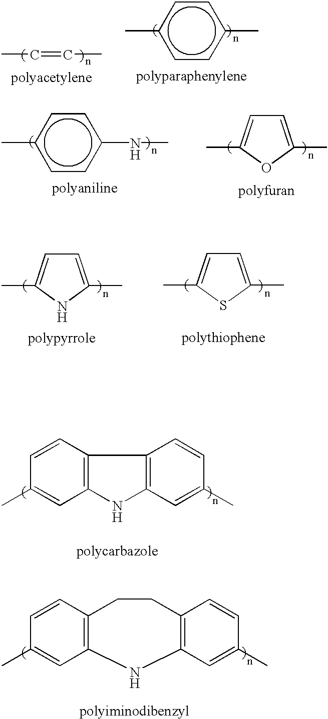

One major characteristic of the electrochemical gaseous chlorine sensor according to the present invention is the use of a conductive polymer material which is sensitive to chlorine gas. An electrode can be more secure and difficult to peel off when said polymer material is covered on the electrode by an electro-polymerization method or a chemical polymerization method. Meanwhile, the sensor according to the present invention has no leakage problem and is easy to be miniaturized.

The electrode material according to the present invention is selected from a metal conductor and a metal with catalytic activities, e.g. a precious metal such as gold, platinum, palladium, lawrencium, etc. The use of a solid polymer electrolyte (SPE) enables a sensor according to the present invention to avoid the disadvantage of leakage existed in the conventional sensor which uses a liquid electrolyte. A typical SPE used by the present invention is the perfluorocarbon polymer. Such polymer is available from the market including cationic exchange films of sulfonic-acid type and carboxylic-acid type, such as Nafion® from DuPont Co., and products from Dow Chemicals, Co. shown in the following:

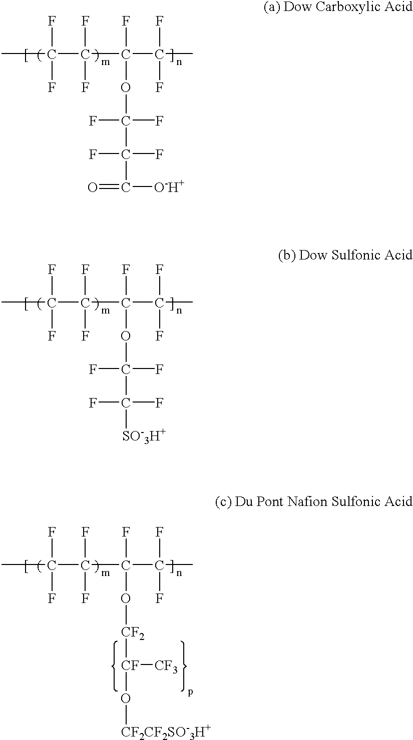

In the following examples, a solid polymer electrolyte film Nafion® 117 from DuPont Co., U.S.A. was used in preparing the chlorine sensors of the present invention. The Nafion®117 film was subjected to a pre-treatment, wherein it was boiled in deionized water for one hour after being cut to a dimension of 3.5 cm×3.5 cm, immersed in methanol for one hour to swell the polymer, followed by washing the polymer with deionized water, boiling the polymer in 3 wt % hydrogen peroxide for 40 minutes to remove organic impurities, boiling the polymer in 1M sulfuric acid for one hour, and washing the polymer with deionized water.

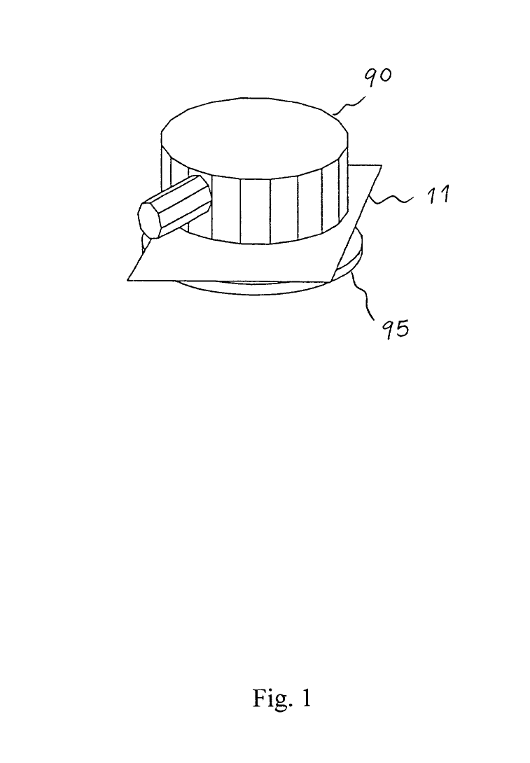

Next, a first electrode and a second electrode were produced by an immersion reduction method. As shown in FIG. 1, a sheet of Nafion®117 11 completed with the pre-treatment was placed on a glass disk 95, a Pt deposition cell 90 was placed on the Nafion®117 sheet and fastened with a gasket (not shown in the drawing). The Nafion®117 sheet was subjected to a Pt ion exchange by introducing a Pt(II)(NH₃)₄ aqueous solution and controlling the temperature of the aqueous solution at 40° C. for two hours, followed by washing with deionized water. Next, the Nafion®117 sheet was subjected to a reduction reaction by introducing NaBH₄ aqueous solution at 40° C., followed by washing with deionized water. Subsequently, the deposited Nafion®117 sheet was subjected to H⁺ exchange with 0.5M H₂SO₄ for one hour to produce a first electrode. The above-mentioned procedures were completed to produce a second electrode on the opposite side thereof.

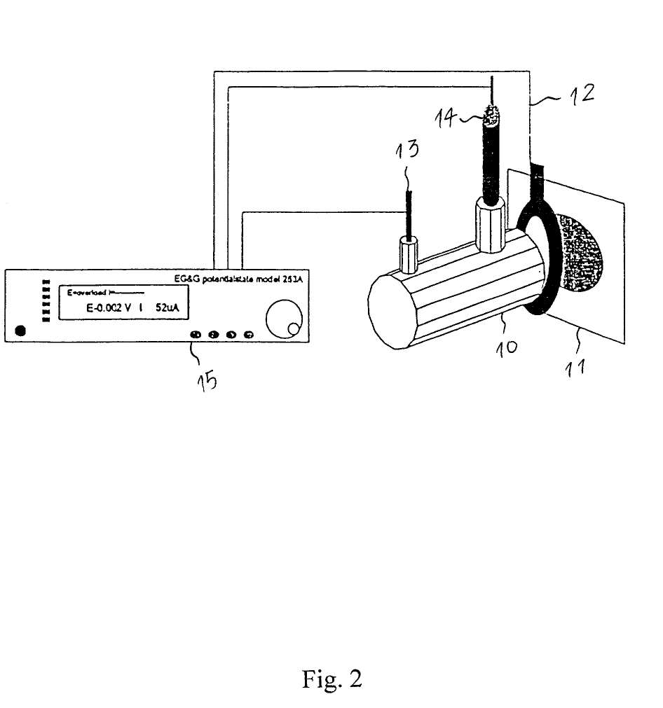

Finally, the coating of a conductive polymer was carried out by polymerizing aniline with a chemical polymerization method or an electro-polymerization method. A cyclic voltametric polymerization method was carried out in a system as shown in FIG. 2 comprising a cell 10 containing 25 ml of an aqueous solution of aniline monomers and a sulfuric acid, the deposited Pt/Nafion®117/Pt sheet 11 sealed to one end of the cell, a current collector 12 fastened between the sheet 11 and the end of the cell 10, a counter electrode of a Pt wire having a diameter of 1 mm 13, an Ag/AgCl reference electrode 14, and a potentiostat 15 connected to the current collector 12, the counter electrode 13, and the reference electrode 14. The potentiostat 15 provides a current to carry out the polymerization reaction of aniline monomers with a cyclic change of voltage to increase the uniformity of the electro-polymerized film, while increasing the adhesivity of the Nafion® film on the Pt electrode.

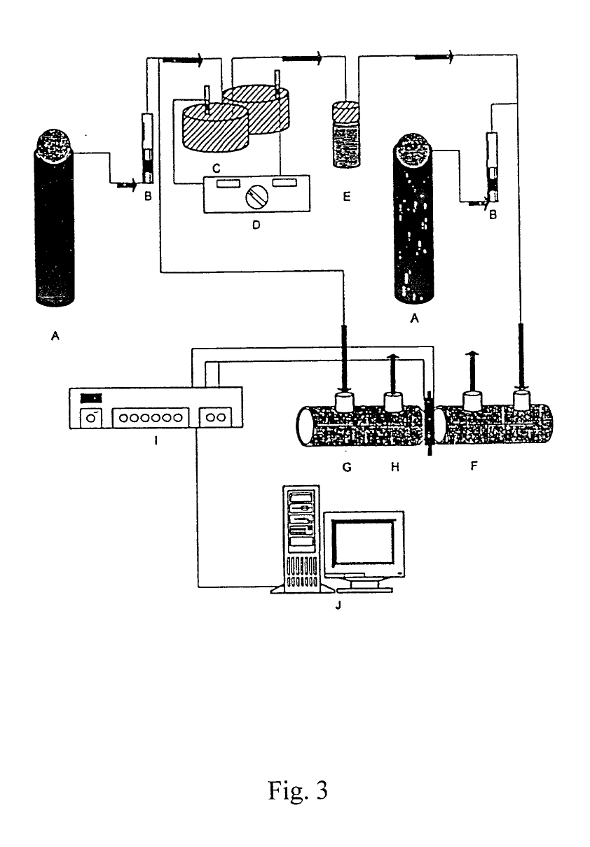

FIG. 3 shows a system used in the following examples for testing a gaseous chlorine sensor of the present invention, which includes nitrogen gas sources A, gas flowmeters B, a Cl₂ gas generator C, a first potentiostat D, a bath of 18 M H₂SO₄, E, a measuring chamber F, a reference chamber G, the sensor H, a second potentiostat 1, and a personal computer J. The arrows in FIG. 3 represent the flowing directions of the gases used in the testing. In order to further elaborate the present invention, several preferred examples are described in the following.

### EXAMPLE 1

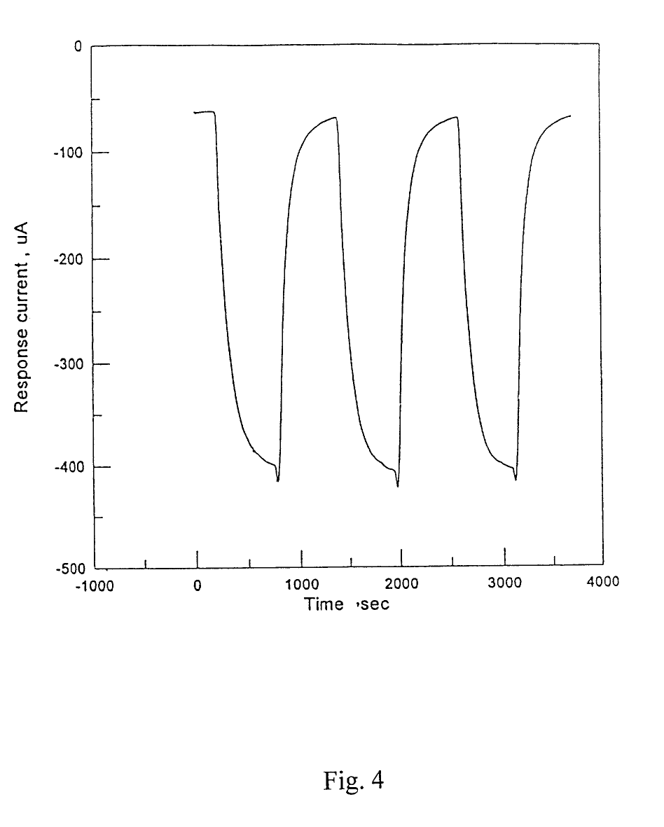

FIG. 4 shows current measured by the second potentiostat (I in FIG. 3) when a PAni-Pt/Nafion/Pt gaseous chlorine sensor of the present invention was used and a gas mixture of N₂ and Cl₂ having a Cl₂ concentration of 101 ppm was flowing into and out from the measuring chamber (F, in FIG. 3). The polyaniline of the PAni-Pt/Nafion/Pt gaseous chlorine sensor was formed under conditions of: monomer concentration 0.2 M aniline, auxiliary electrolyte 0.5 M H₂SO₄, working voltage −0.3⇄1.3V (with respect to reference electrode Ag/AgCl), scanning rate 20 mV/sec, for 20 cycles. The sensing conditions are: working voltage 0 V, gas mixture flowrate 100 mL/min, and concentration of chlorine gas 101 ppm. It can be seen from FIG. 4 that the response shows good reproducibility.

### EXAMPLE 2

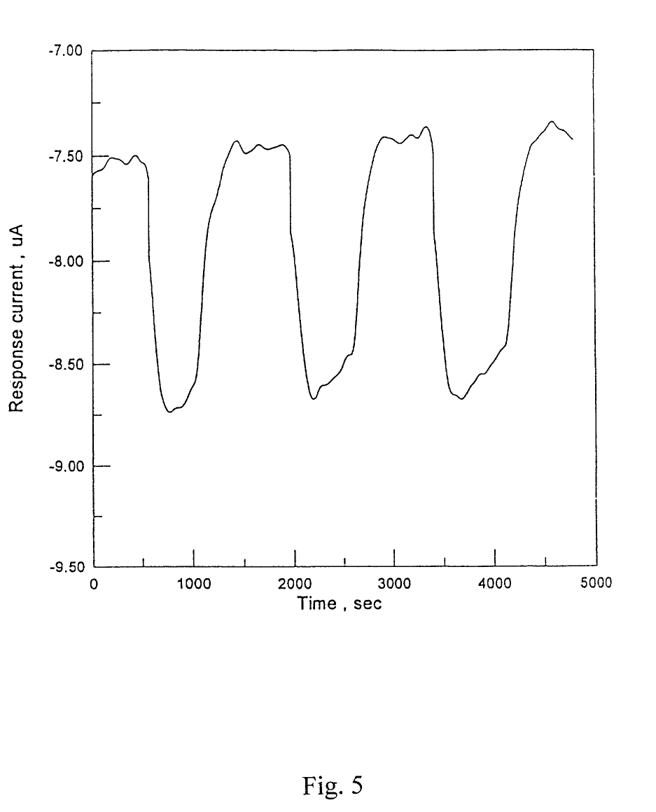

FIG. 5 shows current measured by the second potentiostat (I, in FIG. 3) hen a PAni-Pt/Nafion/Pt gaseous chlorine sensor of the present invention was used and a gas mixture of N₂ and Cl₂ having a Cl₂ concentration of 0.8 ppm was flowing into and out from the measuring chamber (F, in FIG. 3). The polyaniline of the PAni-Pt/Nafion/Pt gaseous chlorine sensor was formed under conditions of: monomer concentration 0.4 M aniline, auxiliary electrolyte 0.5 M H₂SO₄, working voltage −0.3⇄1.3V (with respect to reference electrode Ag/AgCl), scanning rate 20 mV/sec, for 15 cycles. The sensing conditions are: working voltage 0 V, gas mixture flowrate 100 mL/min, and concentration of chlorine gas 0.8 ppm. It can be seen from FIG. 5 that the response shows good reproducibility at a low concentration of Cl₂.

### EXAMPLE 3

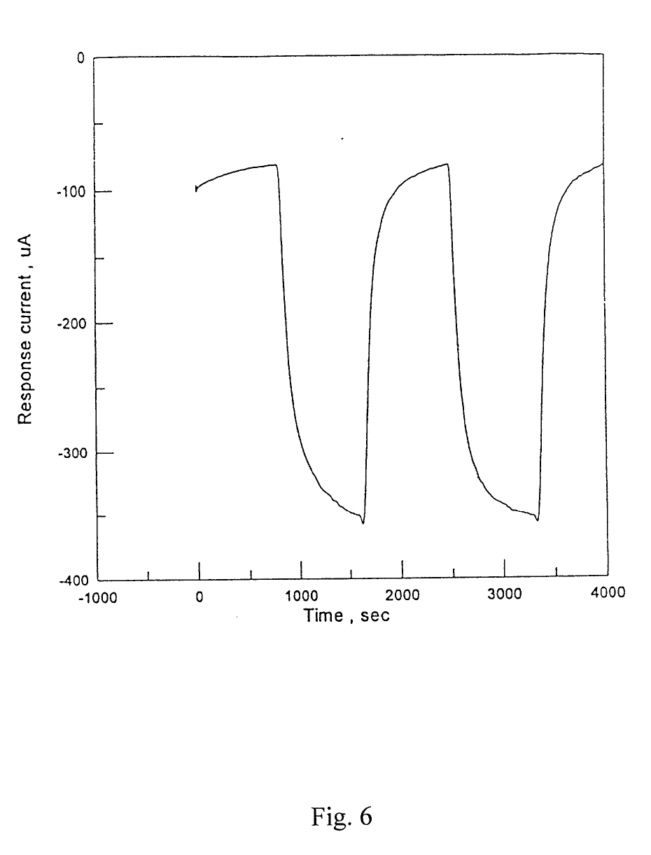

FIG. 6 shows current measured by the second potentiostat (I, in FIG. 3) when a PAni-Pt/Nafion/Pt gaseous chlorine sensor of the present invention was used and a gas mixture of N₂ and Cl₂ having a Cl₂ concentration of 271 ppm was flowing into and out from the measuring chamber (F, in FIG. 3). The polyaniline of the PAni-Pt/Nafion/Pt gaseous chlorine sensor was formed by chemical oxidation polymerization under conditions of: oxidant 0.1M FeCl₃/1N HCl, monomer concentration 0.4 M aniline, polymerization time 100 hours. The sensing conditions are: working voltage −0.1 V, gas mixture flowrate 100 mL/min, and concentration of chlorine gas 271 ppm. It can be seen from FIG. 6 that the chemical oxidation polymerization method also has a good response reproducibility.

### EXAMPLE 4

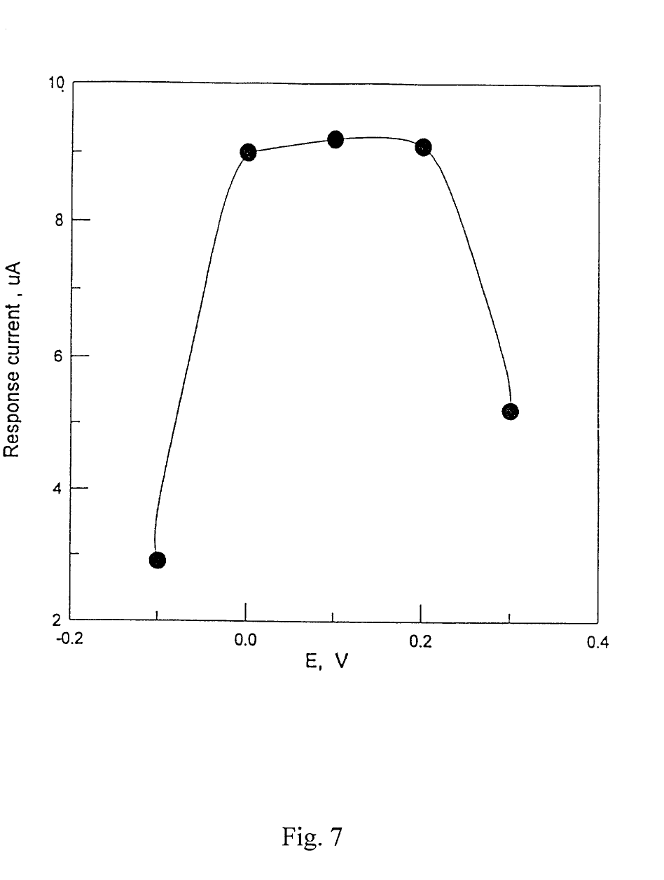

FIG. 7 shows the relationship between the working voltage and the response current, when the procedures of Example 1 were repeated except the concentration of chlorine gas was changed to 2.2 and the working voltage was varied from −0.1 V to 0.3 V. As shown in FIG. 7, a better response current was found within a range from 0 to 0.2V.

### EXAMPLE 5

Table 1 shows the relationship between the response current and the concentration of chlorine gas in different carrier gases, when a PAni-Pt/Nafion/Pt gaseous chlorine sensor of the present invention was tested. There are differences between the response currents measured with the nitrogen gas and the oxygen gas used as the carrier gas. However, a linear relationship between the response current and the concentration of chlorine gas still exists for each carrier gas.

TABLE 1
The relationship between the response current and the
concentration of chlorine gas in different carrier gases*

| | |
|---|---|
| Carrier gas | Response current (μA) |

| Cl₂ (ppm) | Cl₂/N₂ | Cl₂/O₂ |
|---|---|---|
| 2.2 | 8.27 | 11.7 |
| 6.1 | 15.3 | 19.4 |
| 34.0 | 21.1 | 26.2 |
| 68.0 | 34.1 | 38.0 |
| 101.0 | 92.9 | 101.6 |

*The working voltage is 0 V, and the flowrate of the carrier gas is 100 mL/min.

### EXAMPLE 6

Table 2 compares the sensitivity of chlorine gas sensors prepared by different methods. A sensor having a structure of PAni-Pt/Nafion/Pt with the polyaniline formed by a cyclic voltametric polymerization has a maximum sensitivity to chlorine gas.

TABLE 2
Comparison of the sensitivity of chlorine gas for sensors made by
different methods

| | | Sensitivity* |
|---|---|---|
| Sensors | Preparation Method | μA/ppm |
| PAni/Pt/Nafion ®/Pt | Pt deposited by the immersion | 3.96 |
| | reduction method and polyaniline | |
| | formed by the cyclic voltametric | |
| | polymerization method | |
| PAni/Pt/Nafion ®/Pt | Pt deposited by an immersion re- | 0.42 |
| | duction method and polyaniline | |
| | formed by a potentiostatic polym- | |
| | erization method | |
| Pt/Nafion ®/Pt | Pt deposited by the immersion re- | 0.21 |
| | duction method | |
| PAni/Nafion ®/PAni | Polyaniline formed by the chemical | 0.91 |
| | oxidation polymerization method | |
| | (oxidant FeCl₃) | |

*The tests of sensitivity were carried out by using 101 ppm Cl₂ at a flowrate of 100 ml/min and a working voltage of 0 V.

In view of the above-mentioned disclosure, the present invention relates to a dual-electrode type PAni-Pt/Nafion/Pt gaseous chlorine sensor. Such a sensor uses a solid electrolyte and, therefore, is free of the problem of liquid leakage existing in the conventional sensor. Meanwhile, a sensor according to the present invention is easy to be miniaturized. An electro-polymerization method can be used to form a conductive polymer on a Pt electrode thereby fastening the Pt electrode on the porous material film while endowing the electrode with the activity of the conductive polymer. The Pt electrodes used in the examples of the present invention thus have an increased stability in the sensed current, as well as good properties on detecting chlorine gas. The present invention can be modified by a person skilled in the art without departure from the scope of the present invention stipulated in the following claims.

What is claimed is:

1. An electrochemical type gaseous chlorine sensor comprising:
an ionic permeable film, said ionic permeable film being a solid polymer electrolyte (SPE) and being permeable to chlorine gas; and
a first electrode and a second electrode separately formed on two opposite sides of the ionic permeable film, in which said first electrode and said second electrode are a metallic conductor with a catalytic activity;
a conductive polymer film formed on said first electrode.

2. The electrochemical type gaseous chlorine sensor as claimed in claim 1, in which said conductive polymer film is formed on said first electrode by contacting said first electrode with a solution of monomers and polymerizing said monomers with a method selected from the group consisting of a cyclic voltametric polymerization method, a potentiostatic polymerization method, and a chemical oxidation polymerization method.

3. The electrochemical type gaseous chlorine sensor as claimed in claim 2, wherein said conductive polymer film is formed on said first electrode with said cyclic voltametric method and by using aniline as said monomers, which comprises conducting an electrolysis reaction by using said first electrode as a working electrode, said solution as an electrolyte, a counter electrode, and a potential of said first electrode with respect to an Ag/AgCl reference electrode varying from −0.3 to 1.3V with an scanning rate of 20-35 mV/sec, for 10-20 cycles, wherein said solution has a concentration of aniline ranging from 0.05 to 0.4M.

4. The electrochemical type gaseous chlorine sensor as claimed in claim 1, in which said metallic conductor is Pt.

5. The electrochemical type gaseous chlorine sensor as claimed in claim 1, in which said first electrode and said second electrode are gas permeable.

6. The electrochemical type gaseous chlorine sensor as claimed in claim 4, in which Pt is deposited on said ionic permeable film by contacting said ionic permeable film with a solution containing Pt ions and reducing Pt ions adsorbed to said ionic permeable film to Pt metal.

7. The electrochemical type gaseous chlorine sensor as claimed in claim 1, in which said solid polymer electrolyte is a perfluorocarbon polymer.

8. The electrochemical type gaseous chlorine sensor as claimed in claim 1, in which said first electrode and said second electrode are a metallic conductor selected from the group consisting of gold, rhodium and palladium.

9. The electrochemical type gaseous chlorine sensor as claimed in claim 1, in which said conductive polymer film is selected from the group consisting of polyacetylene, polyparaphenylene, polyfuran, polythiophene, polypyrrole, polycarbazole, and polyiminodibenzyl.

10. The electrochemical type gaseous chlorine sensor as claimed in claim 1 further comprising means for maintaining a fixed potential of said first electrode with respect to said second electrode at −0.3 to 1.3V.

11. The electrochemical type gaseous chlorine sensor as claimed in claim 10, in which said means for maintaining a fixed potential of said first electrode with respect to said second electrode at 0 to 0.2V.

12. The electrochemical type gaseous chlorine sensor as claimed in claim 10 further comprising a measuring chamber and a reference chamber, in which said measuring chamber and said reference chamber are separated by said solid polymer electrolyte with said conductive polymer formed on said first electrode being exposed in said measuring chamber, and with said second electrode being exposed in said reference chamber.

13. A method of detecting chlorine gas using the electrochemical type gaseous chlorine sensor as claimed in claim 12 comprising flowing a gaseous mixture through said measuring chamber, flowing a reference gas through said reference chamber, maintaining a fixed potential of said first electrode with respect to said second electrode at −0.3 to 1.3V with said means, and measuring current flowing through said first electrode.

14. The method of detecting chlorine gas as claimed in claim 12, wherein said reference gas is selected from the group consisting of air, nitrogen gas and oxygen gas.

15. The method of detecting chlorine gas as claimed in claim 12, in which said fixed potential of said first electrode with respect to said second electrode is maintained at 0 to 0.2V.
